(19) United States
(12) Patent Application Publication
(10) Pub. No.: US 2008/0113070 A1
(43) Pub. Date: May 15, 2008

(54) Fresh ready onion and spice mix

(76) Inventor: Nagi A. Mansour, Arlington, VA (US)

Correspondence Address: ORION LAW GROUP, 3 HUTTON CENTRE, SUITE 850, SANTA ANA, CA, 92707, US

(21) Appl. No.: 11/560,325

(22) Filed: Nov. 15, 2006

(51) Int. Cl. A23L 1/025; B65B 1/00; B65D 17/28; B65D 85/00

(52) U.S. Cl. 426/108; 426/106; 426/112; 426/122; 426/416; 426/524

(57) ABSTRACT

A frozen onion and spice mix in an exemplary package and method of manufacture. The method of manufacture includes cutting the onion into smaller pieces, adding select spices, freezing the onion spice mix, and packaging the frozen onion spice mix into an exemplary package for retail sale. In one embodiment, the exemplary package includes a plastic tray with multiple compartments covered with a thin transparent plastic covering. Another exemplary package includes a flexible plastic tube crimped at the ends and at multiple points in between to form airtight compartments in between each crimp.

### FIELD OF INVENTION

This invention relates generally to premixed spices. Specifically, the invention relates to spices mixed with blended onions and fresh herbs, and then frozen in an easy to use package.

### BACKGROUND

Spices and fresh herbs are used in the preparation of meals. Proper use of quality spices and fresh herbs can greatly add to the flavor of a dish. The time and knowledge required to properly prepare and use spices and fresh herbs, however, leave many home cooked meals lacking the refined taste of a restaurant dish. Today's dual income families generally lack the knowledge to adequately prepare gourmet meals. With both spouses working, neither spouse can invest the time necessary to learn how spices are prepared, mixed, and used in the preparation of great meals.

Even if a person should possess the requisite culinary knowledge, time and effort are still required to prepare the herbs and spices themselves. For example, removing the skin off garlic buds then mincing them finely is a time intensive procedure. And, anyone who has ever peeled and minced an onion knows the physical discomfort involved.

Grocery stores typically stock dozens of dried spices. Each dried spice will typically come in a small plastic bottle containing five to six ounces of the spice. The problem is that most ingredients call for a pinch or two at most. Considering the hundreds of spices used in food preparation and the small amounts required in any given recipe, stocking even dried spices is inefficient and costly. Most home kitchens cannot adequately stock the variety of spices needed.

Some specialty stores may sell fresh herbs such as parsley, cilantro, bay leaves, basil, lemon grass, and mint. However, selections may vary and finding specific herbs could become a chore. Further, fresh herbs are extremely perishable, thus each recipe calls for a separate trip to the specialty store. Another problem is that the perishable nature of fresh herbs tends to increase their price. Thus cooking with fresh herbs is normally quite an expenditure of both time and money, neither of which today's working couple can afford to spend.

### SUMMARY

An aspect of the invention relates to a first exemplary package containing a frozen mix of onions, fresh herbs, and assorted spices. The exemplary package is comprised of multiple compartments within the package, separated from each other. Each compartment contains a pre-measured amount of onion and herb spice mix. The entire package is frozen for freshness.

Using the first exemplary package, a user would remove one or more compartments and thaw the contents. Methods of thawing may include thawing at room temperature, thawing using a microwave or other heating device, placing the onion and herb spice mix into olive oil or butter and simmer until thawed, or others. The thawed contents would then be added to other ingredients such as meats, broth, and/or vegetables.

The first exemplary package could be manufactured in many ways. One way is to peel and blend the onion into a paste, puree, etc. Then one or more spices and fresh herbs are added to the onion paste depending on the type of mix that is being prepared. The onions, fresh herbs, and spices are mixed thoroughly (e.g., by a blending device) and divided onto pre-measured amounts. Each amount is then placed into the individual compartments of the exemplary package. A layer of transparent cellophane, thin plastic, polyvinylidene chloride, or other material is adhered to the top surface of the exemplary package and the package is then labeled for retail. Finally the package is frozen and delivered to retail sales outlets.

Another aspect of the invention relates to a second exemplary package containing a frozen mix of onions, fresh herbs, and assorted spices. The exemplary package is comprised of multiple compartments made of soft plastic or other suitable material and separated from each other. Each compartment is sealed to preserve freshness and frozen to extend shelf life.

Using this second exemplary package a user would remove one or more compartments by cutting at the crimped area, removing the plastic, and thawing if necessary. The contents would then be added to other ingredients such as meats, broth, vegetables, and/or others.

The second exemplary package could be manufactured in many ways. One way is to peel and blend an onion into a paste, puree, etc. Spices and fresh herbs are then thoroughly mixed with the onion paste and divided into pre-measured amounts. A pre-measured amount of onion and herb spice mix is placed into a plastic tube made of a flexible material crimped at one end. After the onion and herb spice mix is placed in the tube and packed tightly, the tube is crimped and another pre-measured amount is placed in the tube. The process is repeated to form compartments containing a predetermined amount of onion and herb spice mix. The crimped areas are then scored. The crimped tube is then frozen for shipment to retail outlets.

Another aspect of the invention relates to a third exemplary package containing a frozen onion and herb spice mix, vegetables, and meat. The exemplary package is comprised of multiple compartments within the package, separated from each other. One compartment may contain an onion and herb spice mix, another compartment may contain select vegetables, and another compartment may contain select meats (chicken, beef, pork, etc.). The entire package is frozen for freshness.

The third exemplary package may be manufactured in many ways. One way is to peel and blend an onion into a paste, puree, etc. Mix the onion paste with select spices and select fresh herbs to make an onion and herb spice mix. Place a pre-measured amount of the onion and herb spice mix into a compartment of the exemplary package. Place select vegetables into another compartment of the exemplary package. Place select meats (chicken, beef, pork, fish, etc.) into another compartment of the exemplary package. Adhere a layer of transparent cellophane, thin plastic, polyvinylidene chloride, or other material to the top surface of the exemplary package and label the package for retail. Finally, freeze the package and deliver it to retail sales outlets.

Other aspects, features and techniques of the invention will be apparent to one skilled in the relevant art in view of the following detailed description of the exemplary embodiment of the invention.

### BRIEF DESCRIPTION OF THE ILLUSTRATIONS

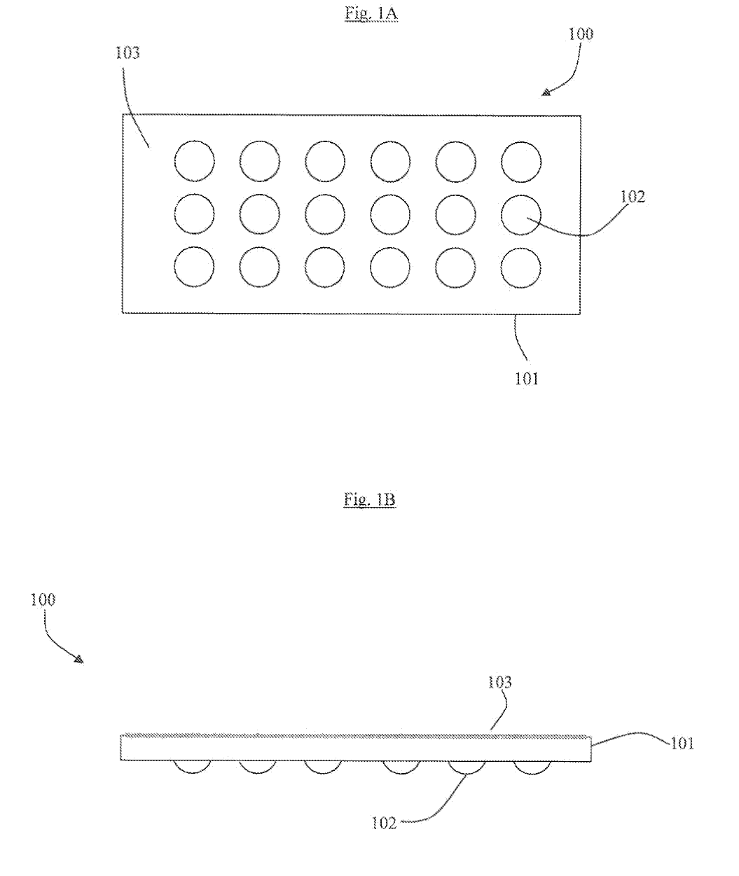

FIG. 1A illustrates a top view of the first exemplary package containing a frozen mix of onions, fresh herbs, and spices in accordance with an embodiment of the invention.

FIG. 1B illustrates a side view of the first exemplary package containing a frozen mix of onions, fresh herbs, and spices in accordance with an embodiment of the invention.

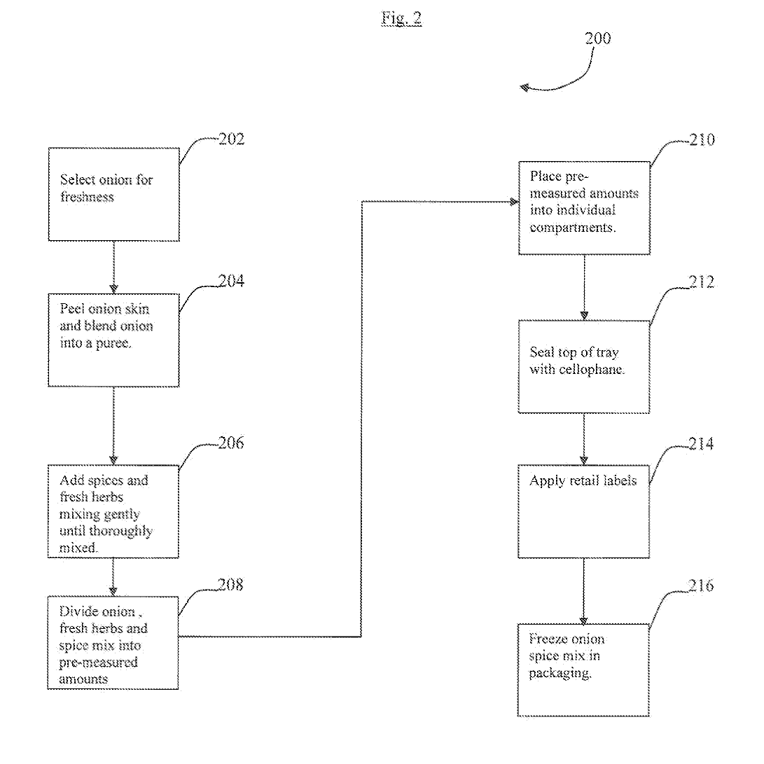

FIG. 2 is a flow chart of a method of manufacturing the first exemplary package containing a frozen mix of onions, fresh herbs, and spices in accordance with an embodiment of the invention.

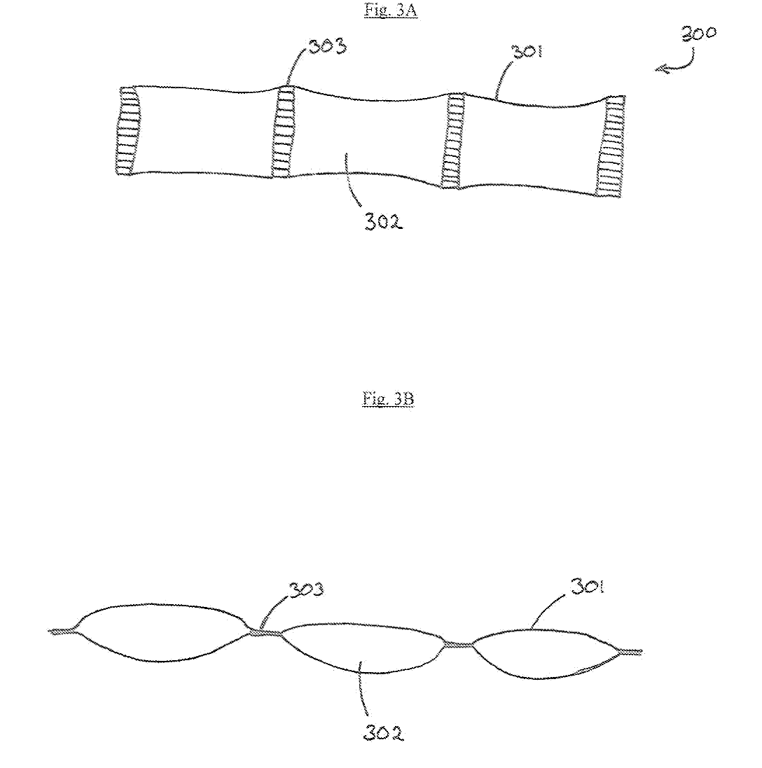

FIG. 3A illustrates a top view of the second exemplary package containing a frozen mix of onions, fresh herbs, and spices in accordance with an embodiment of the invention.

FIG. 3B illustrates a side view of the second exemplary package containing a frozen mix of onions, fresh herbs, and spices in accordance with an embodiment of the invention.

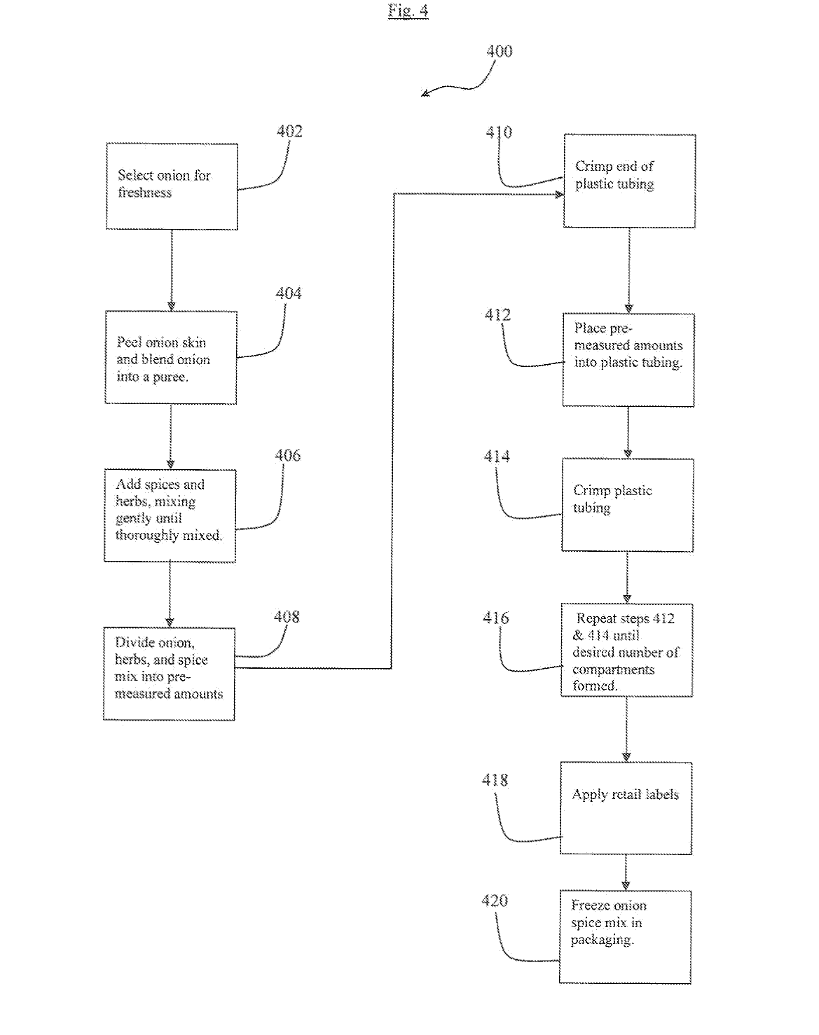

FIG. 4 is a flow chart of a method of manufacturing the second exemplary package containing a frozen mix of onions, fresh herbs, and spices in accordance with an embodiment of the invention.

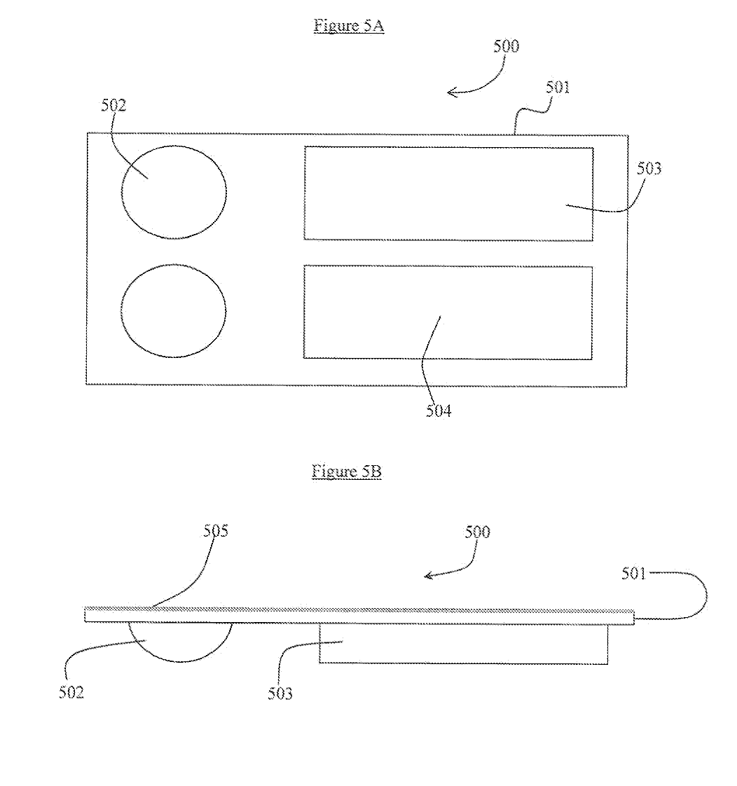

FIG. 5A illustrates a top view of the third exemplary package containing a frozen onion and herb spice mix, vegetables, and meats in accordance with an embodiment of the invention.

FIG. 5B illustrates a side view of the third exemplary package containing a frozen onion and herb spice mix, vegetables, and meat in accordance with an embodiment of the invention.

### DETAILED DESCRIPTION OF THE ILLUSTRATIONS

FIG. 1A illustrates a top view of an exemplary package 100 for a frozen onion and herb spice mix in accordance with an embodiment of the invention. The package 100 comprise a plastic tray 101 with individual compartments 102. The individual compartments 102 may be circular or other shapes, and enclosed on the bottom and open at the top. The individual compartments 102 contain the frozen onion and herb spice mix. The top of the tray 101 may be made of a rigid plastic. The top of the tray 101 may be covered in a transparent cellophane 103 or other material. The cellophane 103 adheres to the tray face at multiple points allowing it to be peeled back from each compartment without exposing nearby compartments. The adhesive used to affix the cellophane 103 to the tray 101, should allow ease of peeling but still retain a seal on the remaining compartments. The tray 101 and cellophane 103 used to form the package 100 may be microwave safe. Furthermore, the tray and cellophane selected may be moisture vapor proof (MVP), so as to withstand the effects of freezing without causing freezer burn on the onion and herb spice mix.

FIG. 1B illustrates a side view of the exemplary package 100. The top of the tray 101 may be made of a rigid plastic which retains its shape under moderate pressure such as expected from storage and transportation. The sides of each compartment 102 may be made of a thinner plastic or other suitable material, which may deform when pressure is applied.

To dispense the onion and herb spice mix, a user firmly grasps both ends of the tray 101 and twists in opposite directions. The tray 101 should flex slightly under the strain and cause the onion and herb spice mix to dislodge from the sides of the compartments 102. A user may then peel back the cellophane 103 exposing one or more compartments 102 as needed. By upending the tray 101 and pushing the bottom of the compartment 102 with a finger or thumb, a user collapses the thin plastic of the compartment 102 thereby forcing the onion and herb spice mix out of the tray.

FIG. 2 illustrates a flowchart of an exemplary method 200 of manufacturing the exemplary package 100. First, onions are selected for freshness and quality (block 202). Care must be taken to select fresh onions with shiny skins without dark patches which may indicate mold. The first few outer layers are then peeled off the onions and discarded (block 204). At this stage the onions are washed, then blended into a paste, puree, etc. Next one or more spices and fresh herbs are added according to the type of mix desired (block 206). Examples of spices and fresh herbs include: oregano, garlic, thyme, paprika, black pepper, jalapeno pepper, sea salt, basil, cinnamon, mint, cilantro and others. Spices and fresh herbs should be added in such amounts as applicable for select recipes. The spices and fresh herbs should be mixed gently with the onion paste, creating a uniform mixture. Next the onion and herb spice mix is divided into pre-measured amounts (block 208). Each pre-measured amount is placed into each compartment of the tray (block 210).

When all compartments are filled, the cellophane is adhered to the surface of the tray (block 212). The surface of the tray should have a sufficient amount of flat surface area such that the cellophane can adhere to the tray at multiple points not occupied by the onion and herb spice mix compartments. The adhesion of the cellophane should be of sufficient strength to allow users to open each individual compartment while keeping unused compartments tightly sealed. Retail labels may be applied either directly to the cellophane or printed on cardboard boxes that will enclose the trays (block 214). The retail labels may be printed with nutritional information as well as cooking suggestions and directions for using the onion spice mix. Finally, the package is frozen and delivered to retail sales outlets (block 216).

FIG. 3A illustrates a top view of another exemplary package 300 for a frozen onion and herb spice mix in accordance with an embodiment of the invention. The package 300 comprise a flexible tube 301 (e.g., a plastic tube), containing multiple compartments 302. Each compartment is formed by crimping the tube at plurality of locations along the tube 301 to form a crimped area 303 and making each compartment 302 airtight. The crimped area 303 can be scored for ease of separation. The material used to form the tube 301 may be transparent to display the onion and herb spice mix and may also be freezer and microwave safe.

FIG. 3B illustrates a side view of the exemplary package 300. The crimped areas 303 are scored for ease of separation. The tube 301 may be thin and flexible yet strong enough to encase the onion spice mix without rupturing under normal storage and transportation.

To dispense the onion and herb spice mix from the package 300, a user simply tears at the scored section of the crimped area 203 separating the desired amount of onion and herb spice mix for use. Once separated, the unused sections may be returned to the freezer. The sections to be used may be thawed if necessary. Once thawed the onion and herb spice mix may be added to other ingredients (e.g. meats, vegetables, etc.) to form a dish.

FIG. 4 illustrates a flowchart of an exemplary method 400 of manufacturing the exemplary package 300 in accordance with an embodiment of the invention. First, onions are selected for freshness and quality (block 402). Care should be taken to select fresh onions with shiny skins without dark patches which may indicate mold. The first few outer layers are then peeled off the onions. At this stage the onions are washed, and blended into a paste, puree, etc. (block 404). Next one or more fresh herbs and spices are added according to the type of mix desired (block 406). Examples of fresh herbs and spices include: oregano, garlic, thyme, paprika, black pepper, jalapeno pepper, sea salt, basil, cinnamon, mint, cilantro and others. Fresh herbs and spices are added in such amounts as applicable for select recipes. The fresh herbs and spices should be mixed gently with the onion, creating a uniform mixture. Next the onion and herb spice mix is divided into pre-measured amounts (block 408).

A flexible tube (e.g. made of a plastic material) forms the casing that holds the onion and herb spice mix. One end of the plastic tube is crimped at the start of manufacture (block 410). One measure of onion and herb spice mix is packed into the tubing (block 412). The tubing is then crimped right behind the measure of onion and herb spice mix forming an airtight pocket crimped at both ends (block 414). The process is repeated until some desired number of compartments is formed (block 416). A variety of methods may be used to crimp the tube ends, including lightly heating the plastic until it melts between two metal surfaces pressed together. Retail labels are applied to the package (block 418). The retail labels may be printed with nutritional information as well as cooking suggestions and directions for the onion and herb spice mix. Finally the package is frozen and delivered to retail sales outlets (block 420).

FIG. 5A illustrates a top view of an exemplary package 500 for a frozen onion and herb spice mix complete meal in accordance with an embodiment of the invention. The package 500 comprise a plastic tray 501 with individual compartments 502 and 503. The individual compartments 502 and 503 may be circular or other shapes, and enclosed on the bottom and open at the top. The individual compartments 502 may contain the frozen onion and herb spice mix. The larger individual compartments 503 would contain vegetables and/or meats (chicken, beef, pork, fish, etc.). The top of the tray 501 may be made of a rigid plastic. The top of the tray 501 may be covered in transparent cellophane 504 or other material. The cellophane 504 adheres to the tray face at multiple points allowing it to be peeled back from each compartment without exposing nearby compartments. The adhesive used to affix the cellophane 504 to the tray 501, should allow ease of peeling but still retain a seal on the remaining compartments. The tray 501 and cellophane 503 used to form the package 500 may be microwave safe. Furthermore, the tray and cellophane selected may be moisture vapor proof (MVP), so as to withstand the effects of freezing without causing freezer burn on the onion spice mix.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which then invention pertains.

It is claimed:

1. A method of manufacturing a frozen onion and herb spice mix, comprising:
forming onion paste from an onion;
mixing one or more spices with said onion paste to form an onion spice mix;
mixing one or more fresh herbs with said onion spice mix to form onion and herb spice mix;
placing said onion and herb spice mix into a package; and
freezing said onion and herb spice mix to form said frozen onion and herb spice mix.

2. The method of claim 1, wherein said onion paste is formed by:
peeling the skin off of said onion;
washing said onion; and
blending said onion into said onion paste.

3. The method of claim 2, wherein said onion is pureed into said onion paste.

4. The method of claim 2, wherein said onion is crushed into said onion paste.

5. The method of claim 1, wherein said one or more spices comprises: oregano, garlic, thyme, paprika, black pepper, jalapeno pepper, salt, sea salt, and/or cinnamon.

6. The method of claim 1, wherein said one or more fresh herbs comprises: parsley, cilantro, bay leaves, basil, lemon grass, and/or mint.

7. The method of claim 1, wherein said frozen onion and herb spice mix is:
packaged in a moisture-vapor-proof (MVP) material; and
labeled for retail sale.

8. A method of cooking comprising:
removing frozen onion and herb spice mix from a package;
thawing said frozen onion and herb spice mix; and
adding the thawed onion and herb spice mix to one or more other ingredients.

9. The method of claim 8, wherein said frozen onion and herb spice mix is removed from the package by cutting or tearing at the scored crimped area of said package.

10. The method of claim 8, wherein said frozen onion and herb spice mix is removed from the package by:
peeling back a peelable cover to expose a desired amount of said frozen onion and herb spice mix;
twisting the package to dislodge frozen onion and herb spice mix; and
upending the package while simultaneously pushing at a bottom of the package to dislodge the frozen onion and herb spice mix.

11. A packaged condiment comprising:
a frozen onion and herb spice mix; and
a package enclosing said frozen onion and herb spice mix.

12. The packaged condiment of claim 11, wherein said package is made of a first moisture-vapor-proof (MVP) plastic.

13. The packaged condiment of claim 12, wherein said package comprise a rigid plastic tray containing a plurality of compartments.

14. The packaged condiment of claim 13, wherein said pluralities of compartments comprise a second MVP plastic thinner than said first MVP plastic.

15. The package of claim 14, wherein an MVP transparent plastic film is attached to said rigid plastic tray.

16. The package of claim 15, wherein said transparent plastic film is attached to said plastic tray at multiple areas.

17. The package of claim 11, wherein said package comprise a flexible tube.

18. The package of claim 17, wherein said tube is crimped at a plurality of locations along said tube to form airtight compartments.

19. The package of claim 18, wherein said frozen onion and herb spice mix is enclosed in said airtight compartments.

20. The package of claim 11, wherein said package includes labels for retail sale comprising:
nutritional information;
ingredients; and/or
cooking suggestions.

21. A packaged meal comprising:
a frozen onion and herb spice mix and one or more of the following;
select vegetables;
select meats; and
a package enclosing said meal.

22. The packaged meal of claim 21, wherein said package is made of a first moisture-vapor-proof (MVP) plastic.

23. The packaged meal of claim 22, wherein said package comprise a rigid plastic tray containing a plurality of compartments.

24. The packaged meal of claim 23, wherein an MVP transparent plastic film is attached to said rigid plastic tray.

25. The package of claim 24, wherein said transparent plastic film is attached to said plastic tray at multiple areas.
